(19) United States
(12) Patent Application Publication
(10) Pub. No.: US 2007/0202217 A1
(43) Pub. Date: Aug. 30, 2007

(54) Process for producing handheld stir-fried rice grain pockets

(76) Inventors: Harold W. Zukerman, Northbrook, IL (US); Rachel B. Zukerman, Northbrook, IL (US)

Correspondence Address: Harold W. Zukerman, 4125 W. Yorkshire Lane, Northbrook, IL, 60062, US

(21) Appl. No.: 11/361,889

(22) Filed: Feb. 27, 2006

(51) Int. Cl. A23L 1/36

(52) U.S. Cl. 426/93

(57) ABSTRACT

The soft-baked stir-fried rice grain pockets of the present invention were developed to be handheld replacements for traditional stir-fried rice grain entrees that have always been consumed from a plate or bowl with a fork or chopsticks. There are numerous recipes for making traditional stir-fried rice grain entrees because every country and culture prefers their own indigenous blends of vegetables, herbs and spices. In the process of the present invention, the ingredients that comprise a traditional stir-fried rice grain entrée are separated into two components, a stir-fried rice grain component and a stir-fried filling component, both of which are comprised of food particles and spices that complement each other so that when said two components are later merged into pocket configurations, they provide the stir-fry taste and the stir-fried rice-grain texture of traditional stir-fried rice grain entrées—but in a handheld format. The stir-fried rice grain component is prepared by stir-frying with non-shear mechanical stirrers, individual rice grains, water, oil, diced and/or sliced vegetables, food particles, seasonings and starch complexing agents at temperatures between 175° F. and 220° F. until said individual rice grains absorb between 200 to 400 pounds of the stir-fry flavored water solution per 100 pounds of dry rice grains and develop soft textures and become bloated with the stir-fry flavored water solution. The stir-fried filling-component is prepared separately. The two stir-fried components are then merged and formed into completely enclosed pockets and open-face pockets. Completely enclosed pockets have a stir-fried filling component enclosed within a stir-fried rice grain component, while the open-face pockets have the stir-fried filling component positioned on top of the stir-fried rice-grain component. The merged and formed stir-fried rice grain pockets are then baked at temperatures between 300° F. and 600° F. until the stir-fried rice grain component develops a soft-baked texture and said pockets become structurally strong enough to be picked-up and consumed handheld.

### BACKGROUND OF THE INVENTION

The stir-fried rice grain pockets of the present invention were developed to be handheld replacements for traditional stir-fried rice grain entrees which have always been consumed from a plate or bowl with a fork or chopsticks.

The prior art teaches how to make traditional stir-fried rice grain entrees by stir-frying individual rice grains, fat, water, soy sauce, pieces of vegetables, meat, poultry and/or seafood together in a wok or frying pan. There are numerous recipes for making traditional stir-fried rice grain entrees because every country and ethnic culture prefers their own indigenous varieties of rice grains, and blends of vegetables, herbs and spices. However, no matter which recipe is used, traditional stir-fried rice grain entrees have always been consumed from a plate or bowl with a fork or chopsticks.

The prior art also teaches how to make bread-dough pocket products such as stuffed pocket sandwiches, stuffed pita-pocket sandwiches, stuffed subway sandwiches, fat-fried egg rolls, pizza rolls, and filled-pasta products such as ravioli, burritos, pasties, and blintzes from a finely-milled wheat flour and water dough which, when “kneaded,” develops special unique properties such as: a) elasticity whereby wheat-gluten-dough sheets can be stretched without tearing; b) uncooked wheat-gluten-dough irreversibly firms when heated; c) wheat-gluten-dough sheets won't tear easily because they are structurally very strong, and d) the gluten structure of the wheat-gluten-dough is able to retain gases so the expansion of said wheat-dough gluten structure can be controlled when baked.

U.S. Pat. No. 5,137,745 Zukerman et al. entitled, Process for Preparing Shaped Grain Products teaches a process for making shaped cereal grain products that have a surface crust with interiors comprised of cooked cereal grains.

U.S. Pat. No. 5,525,366 Zukerman et al. entitled, Process for Preparing Food Products Having Grain Shells and Enclosed Non-Grain Interiors teaches a process for making shaped cereal grain products that have an outer grain shell component comprised of visible, cooked cereal grains and an interior filling component comprised of foods that are substantially free of cereal grains.

### BRIEF SUMMARY OF THE INVENTION

The soft-baked stir-fried rice grain pockets of the present invention were developed to be handheld replacements for traditional stir-fried rice grain entrees that have always been consumed from a plate or bowl with a fork or chopsticks.

There are numerous recipes for making traditional stir-fried rice grain entrees because every country and culture prefers their own indigenous blends of vegetables, herbs and spices. In the process of the present invention, the ingredients that comprise a traditional stir-fried rice grain entrée are separated into two components, a stir-fried rice grain component and a stir-fried filling component, both of which are comprised of food particles and spices that complement each other so that when said two components are later merged into pocket configurations, they provide the stir-fry taste and the stir-fried rice-grain texture of traditional stir-fried rice grain entrées—but in a handheld format.

The stir-fried rice grain component is prepared by stir-frying with non-shear mechanical stirrers, individual rice grains, water, oil, diced and/or sliced vegetables, food particles, seasonings and starch complexing agents at temperatures between 175° F. and 220° F. until said individual rice grains absorb between 200 to 400 pounds of the stir-fry flavored water solution per 100 pounds of dry rice grains and develop soft textures and become bloated with the stir-fry flavored water solution. The stir-fried filling-component is prepared separately.

The two stir-fried components are then merged and formed into completely enclosed pockets and open-face pockets. Completely enclosed pockets have a stir-fried filling component enclosed within a stir-fried rice grain component, while the open-face pockets have the stir-fried filling component positioned on top of the stir-fried rice-grain component. The merged and formed stir-fried rice grain pockets are then baked at temperatures between 300° F. and 600° F. until the stir-fried rice grain component develops a soft-baked texture and said pockets become structurally strong enough to be picked-up and consumed handheld.

It is an object of the present invention to provide a process for making handheld, soft-baked, stir-fried rice-grain pockets comprised of a stir-fried filling component completely-enclosed within a soft-baked, stir-fried rice-grain component; said pockets provide the taste and rice grain texture of a traditional stir-fried rice grain entrée—but in a handheld format.

It is another object of the present invention to provide a process for making handheld, open-face, soft-baked, stir-fried rice-grain pockets comprised of a stir-fried filling component positioned on the top surface of the stir-fried rice grain component; said pockets provide the taste and rice grain texture of a traditional stir-fried rice grain entrée—but in a handheld format.

It is still another object of the present invention to provide a process for making handheld, open-face, soft-baked, stir-fried rice-grain pockets comprised of a stir-fried filling-component stuffed into the concave depression of the soft-baked, stir-fried rice-grain-component; said pockets—provide the taste and rice grain texture of a traditional stir-fried rice grain entrée—but in a handheld format.

### BRIEF DESCRIPTION OF THE DRAWINGS

FIG. 1 illustrates a cross section of a soft-baked, stir-fried rice-grain pocket in which the stir-fried filling-component (1) is completely enclosed within the soft-baked stir-fried, rice-grain component (2).

FIG. 2 illustrates an example of an open-face, soft-baked, stir-fried rice grain pocket having the stir-fried filling-component (3) uniformly dispersed on the top surface of the soft-baked stir-fried, visible rice-grain component (4).

FIG. 3 illustrates an example of an open-face, soft-baked, stir-fried rice-grain pocket e having the stir-fried filling-component (5) stuffed into the concave depression of the soft-baked stir-fried, rice-grain component (6).

### DETAILED DESCRIPTION OF THE PREFERRED EMBODIMENT

The handheld soft-baked, stir-fried rice grain pockets of the present invention were developed to be handheld replacements for the traditional stir-fried rice grain entrees that have always been consumed from a plate or bowl with a fork or chopsticks.

In the process of the present invention, the ingredients that comprise a traditional stir-fried rice grain entrée are separated into two components, a stir-fried rice grain component and a stir-fried filling component, both of which are comprised of food particles and spices that complement each other so that when said two components are later merged into pocket configurations, they provide the stir-fry taste and the stir-fried rice-grain texture of traditional stir-fried rice grain entrées—but in a handheld format.

In the first step of the process of the present invention, the stir-fried filling-component is stir-fried separately. Non-shear stirrers are used to stir-fry the vegetables, poultry, sea food, and meat without destroying their textures. In the process of the present invention the ingredients in the stir-fried filling-component can remain uncooked or are only partially cooked in the stir-frying operation because they are subsequently heated again when the two component pockets are baked.

The stir-fried rice grain component is also stir-fried separately. Non-shear mechanical stirrers are used to stir-fry individual rice grains, water, oil, diced and/or sliced vegetables, food particles, food flavors, colors, seasonings and starch complexing agents at temperatures between 180° F. and 220° F. until said individual rice grains absorb between 200 to 400 pounds of the stir-fry water solution per 100 pounds of dry rice grains and develop sticky surfaces, soft textures, starch-complexed rice grains and become enlarged in size and bloated with the stir-fry water solution. At this point in the stir-frying process, the mechanical stirring is discontinued, thereby allowing the individual rice grains to continue to cook with their retained heat and retained moisture without being ruptured by the mechanical stirrers.

In the process of the present invention, the fat can be added either at the beginning of the stir-frying cycle so that it can stir-fry with the dry individual rice grains before the stir-fry water solution is added, or said fat can be added together with the water, vegetables and flavors during the stir-frying procedure.

Starch complexing agents such as lecithin and monoglycerides can be used to complex the starch of the rice grains so the stir-fried rice grain component will develop improved freeze-thaw stability properties. The starch complexing agents are selected from the group consisting of: monoglycerides, lecithin, calcium, stearoyl-2-lactylate, sodium stearoyl-fumarate, sucrose fatty acids and succinylate monoglycerides, and combinations thereof.

Every country and culture uses their own indigenous varieties of rice grains in their stir-fried rice grain entrees. American consumers prefer long grain white rice whereas Asian consumers prefer the more sticky medium and/or short grain white rice, while consumers who want more healthy rice products prefer brown rice. In the process of the present invention the rice grains that can be used to make the rice grain component can be selected from the group consisting of: short grain, medium grain, long grain and broken-grain white and brown rice, or combinations thereof.

There are numerous recipes for making stir-fried rice grain entrees because every country and culture prefers their own indigenous blends of vegetables, herbs and spices. In the process of the present invention, the ingredients that comprise a traditional stir-fried rice grain entrée are separated into two components, a stir-fried rice grain component and a stir-fried filling component, both of which are comprised of food particles and spices that complement each other so that when said two components are later merged into pocket configurations, they provide the stir-fry taste and the stir-fried rice-grain texture of traditional stir-fried rice grain entrées—but in a handheld format

The stir-fried rice-grain components can be made with food particles and spices selected from the group consisting of: fats and oils, sliced and diced vegetables, onions, green onions, red and green peppers, jalapeno peppers, mushrooms, beans, soy protein, egg, soy sauce, vegetable sauces cheese, rice flour, food colors and flavors, water binders, sugar, salt, spices, herbs and combinations thereof.

Also, in the process of the present invention, the stir-fried filling-components can be made with food particles and spices selected from the group consisting of: beef, poultry, ham, bacon, pork, sea-foods, fish, beans, bean sprouts, green onions, scallions, celery, cilantro, plantains, coconut, cheese, garlic, parsley, avocado, carrots, corn, cabbage, eggs, tomatoes, vegetables, fruit, mushrooms, zucchini, yellow squash, water chestnuts, soybeans, onions, red and green peppers, jalapeno peppers, vegetable oil, fat, food flavors, food colors, vegetable sauces, herbs, spices, sugar, salt, soy protein, cumin, tofu, soy sauce, cocoa, starch, water binders and combinations thereof.

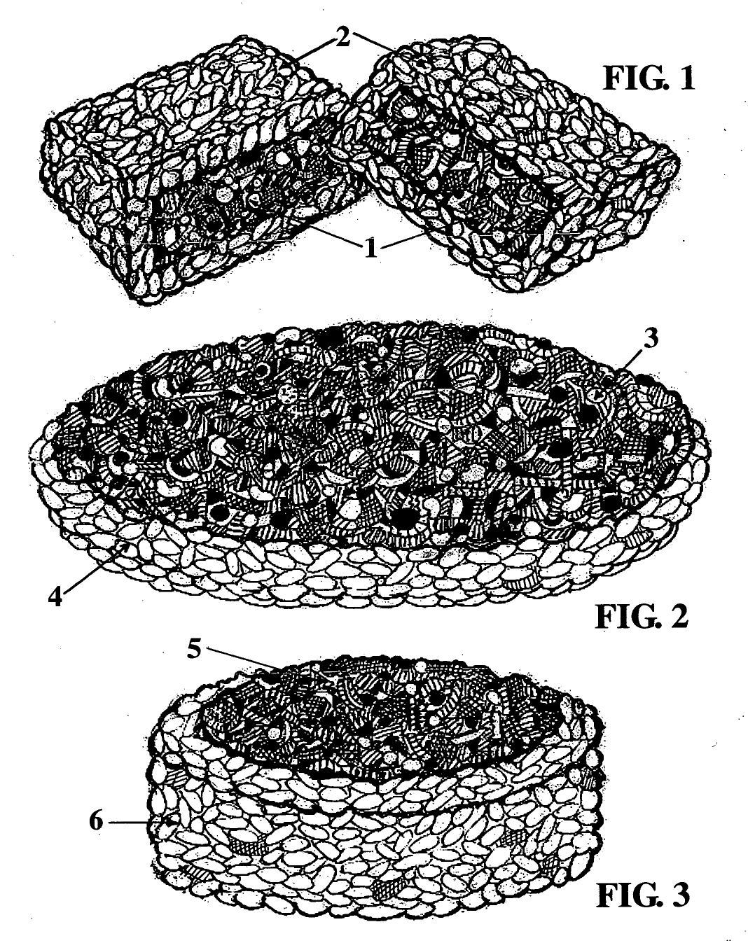

The second step of the process of the present invention, which is the merging of the components and the forming of the pockets, teaches how to merge both the stir-fried rice-grain component and the stir-fried filling-component and then form them into the completely enclosed soft-baked, stir-fried rice grain pockets illustrated in FIG. 1.

One method for forming the completely-enclosed pockets illustrated in FIG. 1 is to first deposit the stir-fried rice grains as a continuous sheet onto a belt-conveyor. Dies are inserted into the continuous sheet of stir-fried rice grains to create multiple-concave-depressions. When the stir-fried rice grains are excessively sticky and adhere to the die, a thin sheet of non-stick material can be inserted between the sheet of stir-fried rice grains and the dies during the formation of the concave depressions. The stir-fried filling component (which was stir-fried separately) is then deposited into the concave depressions. A second continuous sheet of stir-fried rice grains is then layered on top of the first sheet of stir-fried rice grains, thereby enclosing the stir-fried filling component in-between both continuous sheets of stir-fried rice grains. Then, cutters are used to seal and cut the two continuous sheets of stir-fried rice grains with their enclosed deposited filling-component into individual pockets.

A second method for forming the completely-enclosed stir-fried rice grain pockets, as illustrated in FIG. 1, is by simultaneously extruding the stir-fried rice-grain component and the stir-fried filling-component from separate non-shear pumping systems and then merge both components into a configuration whereby the stir-fried filling-component is completely-enclosed within the stir-fried rice-grain component.

The completely enclosed stir-fried rice grain pockets are then heated at temperatures between 300° F. and 600° F. to develop the soft-baked texture of the joined stir-fried rice grain component.

In the process of the present invention the soft-baked textures can also be formed by heating with either: hot air, hot oil, infra-red heat, or by direct contact with hot plates such as grills or combinations thereof. The heating step is needed to both develop the soft-baked texture of the joined stir-fried rice grain component and to make the stir-fried rice grain pockets structurally strong enough to be picked-up and consumed handheld.

The second step of the process of the present invention, which is the merging of the components and the forming of the pockets, also teaches how to merge both the stir-fried rice-grain component and the stir-fried filling-component and then form them into the open-face soft-baked, stir-fried rice grain pockets illustrated in FIG. 2.

One method for forming the open-face, soft-baked stir-fried rice grain pockets illustrated in FIG. 2 is by first depositing a ¼ to one-inch thick sheet of stir-fried rice grains on a belt-conveyor and then cutting said sheet with circular shaped dies to produce individual circular shaped units comprised of joined, visible, stir-fried rice grains, which are then oven-baked at temperatures between 300° F. and 600° F. to develop their soft-baked texture. The stir-fried filling-component (which was stir-fried separately) is then uniformly layered onto the top surface of the soft-baked units.

A second method for forming the open-face, soft-baked stir-fried rice grain pockets illustrated in FIG. 2 is by first depositing a ¼ to one-inch thick sheet of stir-fried rice grains on a belt-conveyor and then cutting said sheet with circular-shaped cutters to produce individual circular-shaped units comprised of stir-fried rice grains. The stir-fried filling-component (which was stir-fried separately) is then uniformly layered onto the top surface of the circular-shaped units comprised of stir-fried rice grains and the two-component are then oven-baked at temperatures between 300° F. and 600° F. to develop the soft-baked texture of the stir-fried rice grain component.

The second step of the process of the present invention, which is the merging of the components and the forming of the pockets, also teaches how to merge both the stir-fried rice-grain component and the stir-fried filling-component and then form them into the open-face soft-baked, stir-fried rice grain pockets illustrated in FIG. 3.

One method for forming the open-face, soft-baked stir-fried rice grain pockets illustrated in FIG. 3 is by first depositing a sheet of stir-fried rice grains on a belt-conveyor. Dies are then inserted into said sheet of stir-fried rice grains to develop multiple concave depressions which are then immediately filled with the stir-fried filling-component (which was stir-fried separately). The continuous sheet of stir-fried rice grains with its filling component stuffed in the multiple concave depressions is then cut into individual open-face stir-fried rice grain pockets and then said open face pockets are oven-baked at temperatures between 300° F. and 600° F. to develop the soft-baked texture of the stir-fried rice grain component.

A second method for forming the open-face stir-fried rice grain pockets illustrated in FIG. 3 is by first depositing a sheet of stir-fried rice grains on a belt-conveyor. Dies are then inserted into said sheet of stir-fried rice grains to develop multiple concave depressions. When the stir-fried rice grains are excessively sticky and adhere to the die, a thin sheet of non-stick material can be inserted between the sheet of joined stir-fried rice grains and the dies during the formation of the concave depressions. Cutters are then used to cut the continuous sheet of stir-fried rice grains into individual unfilled open-face pockets which are then oven-baked at temperatures between 300° F. and 600° F. to develop the soft-baked texture of the stir-fried rice grains. Then, the stir-fried filling component (which was stir-fried separately) is deposited into the concave depressions of the soft baked open-face stir-fried rice grain pockets. If desired, the soft-baked stir-fried rice grain pockets can be frozen and stored frozen.

The following Example will further illustrate the invention, but it is not intended that the invention be limited to the details set forth therein:

### EXAMPLE

This Example teaches a process for making Asian-Flavored Soft-Baked Stir-Fried Rice Grain Pockets having a Completely-Enclosed Beef Pepper Steak Filling Component.

### Formula: Asian-Flavored Stir-Fried Rice Grain Component

| Ingredients | Percent |
|---|---|
| Medium Grain White Rice | 20.0 |
| Water* | 60.0 |
| Diced Scallions | 3.5 |
| Peanut and Sesame Oils | 3.4 |
| Diced Carrots | 2.5 |
| Diced Red Pepper | 1.5 |
| Diced Garlic | 1.0 |
| Waxy Rice Flour | 1.5 |
| Soy Sauce | 1.5 |
| Salt | 0.8 |
| Sugar | 1.5 |
| Food Flavors | 2.5 |
| Monoglycerides and Lecithin | 0.3 |
| Total: | 100.0 |

Note:
Some of the added water will evaporate during both stir-frying and baking.

### Formula: Asian-Flavored Stir-Fried Filling-Component

| Ingredients | Percent |
|---|---|
| Cooked Beef Chunks | 40.0 |
| Diced Red and Green Peppers | 40.0 |
| Diced Scallions Onions and Garlic | 10.0 |
| Soy Sauce | 6.0 |
| Salt, Sugar and Pepper | 2.0 |
| Modified Food Starch | 2.0 |
| Totals | 100.0 |

### Process

The ingredients that comprise an Asian-flavored stir-fried rice grain pocket are separated into two components, a stir-fried rice grain component and a stir-fried filling-component, both of which complement each other so when they are merged and formed into the two-component stir-fried rice grain pockets and then heated to develop their soft-baked texture, said pockets provide the stir-fried taste and stir-fried rice grain texture of Asian flavored stir-fried rice grain entrees—but in a handheld format.

In the first step of the process, both the stir-fried rice grain component and the stir-fried filling component are prepared separately. The stir-fried rice grain component is prepared by stir-frying the ingredients with mechanical non-shear stirrers at about 200° F. until the stir-fry fluid is infused into the rice grains which then become enlarged in size and soft in texture. The mechanical stirring is then discontinued while the rice grains continue to cook with their retained heat and stir-fry fluid. The stir-fried filling component is only partially cooked because it will receive an additional heat treatment when the units are subsequently baked.

In this example, the completely-enclosed pockets are formed by first depositing a continuous sheet of stir-fried rice grains onto a belt-conveyor. Then, dies are plunged into the continuous sheet of stir-fried rice grains to create concave depressions. The stir-fried filling-component, which was developed separately, is then deposited into the concave depressions of said continuous sheet of stir-fried rice grains. A second continuous sheet of stir-fried rice grains is then layered on top of the first continuous sheet of stir-fried rice grains. Then, the two continuous stir-fried rice grain sheets are cut and sealed into completely-enclosed individual units which are then baked at 400° F. to develop the soft-baked texture of the stir-fried rice grain component and make said pockets structurally strong enough to be picked-up and consumed handheld.

It is to be understood that the above described process and example are simply illustrative of the application of principles of the invention and many other modifications may be made without departing from the spirit and scope of the invention. The embodiments of the invention in which an exclusive property or privilege is claimed are defined as follows:

We claim:

1. A process for producing handheld, soft-baked, stir-fried, rice-grain pockets comprised of a stir-fried filling-component completely enclosed within a soft-baked, stir-fried, rice-grain component; said process comprising the steps of:
a) stir-frying the ingredients which comprise the stir-fried rice-grain component;
b) stir-frying the ingredients which comprise the filling-component;
c) merging and then forming the two stir-fried components of 1a) and 1b) into stir-fried rice grain pockets comprised of the stir-fried filling-component completely enclosed within the stir-fried rice-grain component;
d) heating the formed stir-fried rice grain pockets of 1c) at temperatures between 300° F. and 600° F. until the stir-fried rice-grain component develops a soft-baked texture and the pockets become structurally strong enough to be picked-up and consumed handheld.

2. The process of claim 1 wherein the rice grains are selected from the group consisting of: short grain, medium grain, long grain, and broken grain white and brown rice or combinations thereof.

3. The process set forth in claim 1 which further comprises starch complexing the rice grains with starch complexing agents selected from the group consisting of: monoglycerides, lecithin, calcium, stearoyl-2-lactylate, sodium stearoyl-fumarate, sucrose fatty acids and succinylate-monoglycerides, and combinations thereof.

4. The process set forth in claim 1 which further comprises making the stir-fried rice grain component with ingredients selected from the group consisting of: sliced and/or diced vegetables, food particles, eggs, vegetable oil, onions, red and green peppers, green onions, jalapeno peppers, mushrooms, bean sprouts, beans, soy protein, soy sauce, vegetable sauces, cheese, rice flour, water binders, food flavors, salt, spices, herbs and combinations thereof.

5. The process set forth in claim 1 which further comprises making the stir-fried filling component with ingredients selected from the group consisting of: sliced, diced or ground chunks of beef, poultry, ham, bacon, pork, sea-foods, fish, beans, bean sprouts, green onions, scallions, celery, cilantro, plantains, coconut, cheese, garlic, parsley, avocado, carrots, corn, cabbage, eggs, tomatoes, vegetables, fruit, mushrooms, zucchini, yellow squash, water chestnuts, soybeans, onions, red and green peppers, jalapeno peppers, vegetable oil, fat, food flavors, food colors, vegetable sauces, herbs, spices, sugar, salt, soy protein, cumin, paprika, tofu, soy sauce, cocoa, starch, water binders and combinations thereof.

6. The process set forth in claim 1 which further comprises merging and forming the two stir-fried components into stir-fried rice grain pockets by: first depositing the stir-fried rice grains as a continuous sheet; forming multiple concave depressions into said continuous sheet; depositing the separately prepared stir-fried filling-component into the concave depressions of said continuous sheet; layering a second continuous sheet of stir-fried rice grains on top of the first continuous sheet of stir-fried rice grains; and then sealing and cutting the continuous sheets of joined stir-fried rice grains into individual pocket products comprised of the stir-fried filling component completely enclosed within the stir-fried rice grain component.

7. The process set forth in claim 6 which further comprises inserting a sheet of non-stick material between the stir-fried rice grains and dies when the concave depressions are formed.

8. The process set forth in claim 1 which further comprises forming the stir-fried rice grain pockets by simultaneously pumping both the stir-fried rice grain component and the stir-fried filling component with separate non-shear pumping systems into pockets comprised of the stir-fried filling component completely enclosed within the stir-fried rice grain component.

9. The process of claim 1 which further comprises oven-baking the stir-fried rice grain pockets at temperatures between 300° F. and 600° F. until the stir-fried rice grain component develops a soft-baked texture and said pockets become structurally strong enough to be picked-up and consumed handheld.

10. The process of claim 1 which further comprises fat-frying the stir-fried rice grain pockets at temperatures between 300° F. and 600° F. until the stir-fried rice grain component develops a soft-baked texture and said pockets become structurally strong enough to be picked-up and consumed handheld.

11. The process of claim 1 which further comprises freezing the stir-fried rice grain pockets.

12. A process for producing handheld, open-face, soft-baked, stir-fried rice grain pockets having the stir-fried filling-component positioned on top of the soft-baked, stir-fried rice grain component; said process comprising the steps of:
a) stir-frying the ingredients which comprise the stir-fried rice grain component;
b) stir-frying the ingredients which comprise the filling-component;
c) forming the stir-fried rice grain component of 12a) into shaped units;
d) heating the shaped units of 12c) at temperatures between 300° F. and 600° F. until said units develop a soft-baked texture and become structurally strong enough to be picked-up and consumed handheld;
e) depositing the stir-fried filling-component of 12b) on top of the soft-baked stir-fried rice-grain component of id).

13. The process set forth in claim 12 wherein the rice grains are selected from the group consisting of: short grain, medium grain, long grain and broken grain white and brown rice or combinations thereof.

14. The process set forth in claim 12 which further comprises starch complexing the rice grains with starch complexing agents selected from the group consisting of: monoglycerides, lecithin, calcium, stearoyl-2-lactylate, sodium stearoyl-fumarate, sucrose fatty acids and succinylate monoglycerides, and combinations thereof.

15. The process set forth in claim 12 which further comprises making the stir-fried rice-grain component with ingredients selected from the group consisting of: vegetables, food particles, eggs, oil, onions, peppers, jalapeno peppers, mushrooms, beans, soy sauce, vegetable sauces, cheese, rice flour, water binders, food flavors, salt, spices, herbs and combinations thereof.

16. The process set forth in claim 12 which further comprises making the stir-fried filling-component with ingredients selected from the group consisting of: sliced, diced or ground chunks of beef, poultry, ham, bacon, pork, sea-foods, fish, beans, bean sprouts, green onions, scallions, celery, cilantro, plantains, coconut, cheese, garlic, parsley, avocado, carrots, corn, cabbage, eggs, tomatoes, vegetables, fruit, mushrooms, zucchini, yellow squash, water chestnuts, soybeans, onions, red and green peppers, jalapeno peppers, vegetable oil, fat, food flavors, food colors, vegetable sauces, herbs, spices, sugar, salt, soy protein, cumin, paprika, tofu, soy sauce, starch, water binders and combinations thereof.

17. The process set forth in claim 12 which further comprises forming flat surfaced stir-fried rice grain units by depositing the stir-fried rice grains as a ¼ to one inch thick continuous sheet and then cutting said continuous sheet into individual units comprised of joined stir-fried rice grains.

18. The process set forth in claim 12 which further comprises forming stir-fried rice grain units having concave depressions by depositing the stir-fried rice grains as a continuous sheet; forming multiple concave depressions into said continuous sheet; and then cutting said continuous sheet into individual units.

19. The process set forth in claim 18 which further comprises inserting a sheet of non-stick material between the stir-fried rice grains and dies when the concave depressions are formed.

20. The process of claim 12 which further comprises oven-baking the formed units of stir-fried rice grains at temperatures between 300° F. and 600° F. until they develop a soft-baked texture and become structurally strong enough to be picked-up and consumed handheld.

21. The process of claim 12 which further comprises fat-frying the formed units of stir-fried rice grains at temperatures between 300° F. and 600° F. until their soft-baked texture develops and said units become structurally strong enough to be picked-up and consumed handheld.

22. The process of claim 12 which further comprises freezing the open-face pockets.

23. A process for producing handheld, open-face, soft-baked, stir-fried rice grain pockets having a stir-fried filling-component on the top of a soft-baked, stir-fried, rice-grain component; said process comprising the steps of:
a) stir-frying the ingredients which comprise the stir-fried rice grain component;
b) stir-frying the ingredients which comprise the filling-component;
c) merging the two stir-fried components and then forming them into open-face pockets comprised of the stir-fried filling-component topped onto the stir-fried rice grain component;
d) oven-baking the open-face pockets of 1c) at temperatures between 300° F. and 600° F. until the stir-fried rice grain component develops a soft-baked texture and the open-face pockets become structurally strong enough to be picked-up and consumed handheld.

24. The process of claim 23 wherein the rice grains are selected from the group consisting of: short grain, medium grain, long grain, broken grain white and brown rice or combinations thereof.

25. The process set forth in claim 23 which further comprises starch complexing the rice grains with starch complexing agents selected from the group consisting of: monoglycerides, lecithin, calcium, stearoyl-2-lactylate, sodium stearoyl-fumarate, sucrose fatty acids and succinylate monoglycerides, and combinations thereof.

26. The process set forth in claim 23 which further comprises making the stir fried rice grain component with ingredients selected from the group consisting of: vegetable oil, sliced and diced vegetables, food particles, eggs, onions, red and green peppers, jalapeno peppers, mushrooms, beans, soy protein, soy sauce, vegetable sauces and pastes, cheese, rice flour, water binders, food flavors, salt, spices, herbs and combinations thereof.

27. The process set forth in claim 23 which further comprises making the stir-fried filling-component with ingredients selected from the group consisting of: sliced or diced, beef, poultry, ham, bacon, pork, sea-foods, fish, vegetables, beans, bean sprouts, green onions, scallions, celery, cilantro, plantains, coconut, cheese, garlic, parsley, avocado, carrots, corn, cabbage, eggs, tomatoes, fruit, mushrooms, zucchini, yellow squash, water chestnuts, soybeans, onions, red and green peppers, jalapeno peppers, vegetable oil, fat, food flavors, food colors, vegetable sauces, herbs, spices, paprika, sugar, salt, soy protein, cumin, tofu, soy sauce, starch, water binders and combinations thereof.

28. The process set forth in claim 23 whereby open-face pockets are formed by depositing the stir-fried rice grains as a continuous sheet; forming multiple concave depressions in said continuous sheet; depositing the stir-fried filling-component into the concave depressions of said continuous sheet and then cutting said continuous sheet of stir-fried rice grains with deposited stir-fried filling component into individual open-face pockets.

29. The process set forth in claim 23 whereby open-face pockets comprised of the stir-fried filling-component topped onto the stir-fried rice grain component are made by depositing a ¼ to one inch thick continuous sheet of stir-fried rice grains onto a belt-conveyor; layering the stir-fried filling-component uniformly on the surface of said continuous sheet and then cutting said continuous sheet into the open-face pockets.

30. The process of claim 23 which further comprises freezing the entrees.
